(19) United States
(12) Patent Application Publication
(10) Pub. No.: US 2012/0103073 A1
(43) Pub. Date: May 3, 2012

(54) Solvent Feed Systems For Chromatography Systems And Methods Of Making And Using The Same

(76) Inventors: Josef P. Bystron, Chicago, IL (US); Dirk Helgemo, Shakopee, MN (US); Sheldon Nelson, Plymouth, MN (US); James Anderson, JR., Arlington Heights, IL (US); Washington Mendoza, Lake in the Hills, IL (US); Raaidah Saari-Nordhaus, Antioch, IL (US); Steven Lewis, Bloomington, MN (US); Nick Klein, Coon Raplds, MN (US); Bruce Frohman, St. Louis Park, MN (US)

(21) Appl. No.: 13/139,030

(22) PCT Filed: Dec. 10, 2009
(86) PCT No.: PCT/US09/06494

§ 371 Date: Jan. 12, 2012

Related U.S. Application Data
(60) Provisional application No. 61/201,425, filed on Dec. 10, 2008.

(51) Int. Cl. B01D 15/10; B23P 19/00; B67D 7/02; G01N 30/02; B67D 7/58

(52) U.S. Cl. 73/61.53; 222/255; 222/25; 222/1; 137/15.01; 222/251; 210/198.2

(57) ABSTRACT

Solvent feed systems are disclosed. Chromatography systems containing a solvent feed system are also disclosed. Methods of making and using solvent feed systems are further disclosed.

### FIELD OF THE INVENTION

The present invention is directed to solvent feed systems. The present invention is also directed to methods of making and using solvent feed systems such as in chromatography devices and systems.

### BACKGROUND OF THE INVENTION

There is a need in the art for solvent feed systems that are capable of providing one or more of the following features: gradient mixing of two or more solvents, low pressure mixing in combination with high pressure mixing of two or more solvents, monitoring of solvent feed levels without the use of an air pump (i.e., a bubbler device), and a minimal level of user interaction.

### SUMMARY OF THE INVENTION

The present invention addresses some of the difficulties and problems discussed above by the discovery of solvent feed systems components that provide one or more advantages over known solvent feed systems, particularly solvent feed systems used in chromatography devices and systems. The one or more advantages may include, but are not limited to, gradient mixing of two or more solvents, low pressure mixing and high pressure mixing of two or more solvents, monitoring of solvent feed levels without the use of an air pump (i.e., a bubbler device), and a minimal level of user interaction.

In one exemplary embodiment, the solvent feed system of the present invention comprises two or more solvent line connections; at least two pumps, wherein each pump of the at least two pumps (i) is in fluid communication with each solvent line connection, and (ii) is in a parallel configuration relative to any other pump of the at least two pumps; and multiple valves comprising a valve positioned between each solvent line connection and each of the at least two pumps.

In another exemplary embodiment, a solvent feed system comprises a manifold having at least two valves; at least two first solvent lines in fluid communication with the valves; at least one pump in fluid communication with the valves through the solvent lines; and at least one second solvent line; wherein the first solvent lines are in fluid communication with each other before or at an inlet of the pump and in fluid communication with the second solvent line after an outlet of the pump.

In another exemplary embodiment, the solvent feed system of the present invention comprises at least one solvent container; at least one solvent level sensor positioned within each solvent container; and at least one room pressure sensor; wherein the at least one solvent level sensor is operatively adapted to determine a solvent level within a solvent container based on a room pressure reading from the at least one room pressure sensor.

The present invention is further directed to chromatography systems comprising one or more of the herein disclosed solvent feed systems. In one exemplary embodiment, the chromatography system comprises a solvent feed system comprising two or more solvent line connections; at least two pumps, wherein each pump of the at least two pumps (i) is in fluid communication with each solvent line connection, and (ii) is in a parallel configuration relative to any other pump of the at least two pumps; and multiple valves comprising a valve positioned between each solvent line connection and each of the at least two pumps.

In another exemplary embodiment, the chromatography system comprises a solvent feed system comprising at least one solvent container; at least one solvent level sensor positioned within each solvent container; and at least one room pressure sensor; wherein the at least one solvent level sensor is operatively adapted to determine a solvent level within a solvent container based on a room pressure reading from the at least one room pressure sensor.

In yet another exemplary embodiment, the chromatography system comprises a solvent feed system comprising two or more solvent line connections; at least two pumps, wherein each pump of the at least two pumps (i) is in fluid communication with each solvent line connection, and (ii) is in a parallel configuration relative to any other pump of the at least two pumps; multiple valves comprising a valve positioned between each solvent line connection and each of the at least two pumps; at least one solvent container; at least one solvent level sensor positioned within each solvent container; and at least one room pressure sensor; wherein the at least one solvent level sensor is operatively adapted to determine a solvent level within a solvent container based on a room pressure reading from the at least one room pressure sensor. Any of the disclosed chromatography systems comprising one or more of the herein disclosed solvent feed systems may comprise, for example, a flash chromatography system.

The present invention is also directed to methods of making solvent feed systems, as well as chromatography systems comprising one or more of the herein disclosed solvent feed systems. In one exemplary embodiment, the method of making a solvent feed system comprises providing two or more solvent line connections; connecting at least two pumps to the two or more solvent line connections, wherein each pump of the at least two pumps (i) is in fluid communication with each solvent line connection, and (ii) is in a parallel configuration relative to any other pump of the at least two pumps; and positioning a valve between each solvent line connection and each pump of the at least two pumps.

In another exemplary embodiment, a method of making a solvent feed system, said method comprising providing a manifold having at least two valves; connecting at least two first solvent lines to the valves; connecting at least one pump to the two or more solvent lines such that the pump is in fluid communication with the valves; providing at least one second solvent line; wherein the first solvent lines are in fluid communication with each other before or at an inlet of the pump and in fluid communication with the second solvent line after an outlet of the pump.

In another exemplary embodiment, the method of making a solvent feed system comprises positioning at least one solvent level sensor within each solvent container of the system; and providing at least one room pressure sensor in a room containing each solvent container of the system; wherein the at least one solvent level sensor is operatively adapted to determine a solvent level within a solvent container based on a room pressure reading from the at least one room pressure sensor.

The present invention is further directed to methods of using one or more of the above-described solvent feed systems of the present invention. Methods of using one or more of the above-described solvent feed systems of the present invention may comprise using one or more of the above-described solvent feed systems to introduce a solvent stream into a chromatography column. Methods of using one or more of the above-described solvent feed systems of the present invention may comprise using one or more of the above-described solvent feed systems to analyze a test sample in a chromatography system, such as a flash chromatography system.

These and other features and advantages of the present invention will become apparent after a review of the following detailed description of the disclosed embodiments and the appended claims.

### BRIEF DESCRIPTION OF THE FIGURES

FIG. 1 depicts an exemplary solvent feed system of the present invention;

FIG. 2 depicts another exemplary solvent feed system of the present invention; and

FIGS. 3A-3B depict exemplary chromatography systems containing the exemplary solvent feed systems shown in FIGS. 1 and 2 respectively.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

It must be noted that as used herein and in the appended claims, the singular forms “a”, “and”, and “the” include plural referents unless the context clearly dictates otherwise. Thus, for example, reference to “a solvent” includes a plurality of such solvents and reference to “solvent” includes reference to one or more solvents and equivalents thereof known to those skilled in the art, and so forth.

“About” modifying, for example, the quantity of an ingredient in a composition, concentrations, volumes, process temperatures, process times, recoveries or yields, flow rates, and like values, and ranges thereof, employed in describing the embodiments of the disclosure, refers to variation in the numerical quantity that may occur, for example, through typical measuring and handling procedures; through inadvertent error in these procedures; through differences in the ingredients used to carry out the methods; and like proximate considerations. The term “about” also encompasses amounts that differ due to aging of a formulation with a particular initial concentration or mixture, and amounts that differ due to mixing or processing a formulation with a particular initial concentration or mixture. Whether modified by the term “about” the claims appended hereto include equivalents to these quantities.

As used herein, the term “chromatography” means a physical method of separation in which the components to be separated are distributed between two phases, one of which is stationary (stationary phase) while the other (the mobile phase) moves in a definite direction.

As used herein, the term “liquid chromatography” means the separation of mixtures by passing a fluid mixture dissolved in a “mobile phase” through a column comprising a stationary phase, which separates the analyte (i.e., the target substance) from other molecules in the mixture and allows it to be isolated.

As used herein, the term “mobile phase” means a fluid liquid, a gas, or a supercritical fluid that comprises the sample being separated and/or analyzed and the solvent that moves the sample comprising the analyte through the column. The mobile phase moves through the chromatography column or cartridge (i.e., the container housing the stationary phase) where the analyte in the sample interacts with the stationary phase and is separated from the sample.

As used herein, the term “stationary phase” or “media” means material fixed in the column or cartridge that selectively adsorbs the analyte from the sample in the mobile phase separation of mixtures by passing a fluid mixture dissolved in a “mobile phase” through a column comprising a stationary phase, which separates the analyte to be measured from other molecules in the mixture and allows it to be isolated.

As used herein, the term “flash chromatography” means the separation of mixtures by passing a fluid mixture dissolved in a “mobile phase” under pressure through a column comprising a stationary phase, which separates the analyte (i.e., the target substance) from other molecules in the mixture and allows it to be isolated.

As used herein, the term “fluid” means a gas, liquid, and supercritical fluid.

As used herein, the term “substantially” means within a reasonable amount, but includes amounts which vary from about 0% to about 50% of the absolute value, from about 0% to about 40%, from about 0% to about 30%, from about 0% to about 20% or from about 0% to about 10%.

The present invention is directed to solvent feed systems. The present invention is further directed to methods of making solvent feed systems, as well as chromatography systems containing one or more of the herein disclosed solvent feed systems. The present invention is even further directed to methods of using one or more of the herein disclosed solvent feed systems in fluid flow systems including, but not limited to, chromatography systems such as a flash chromatography systems.

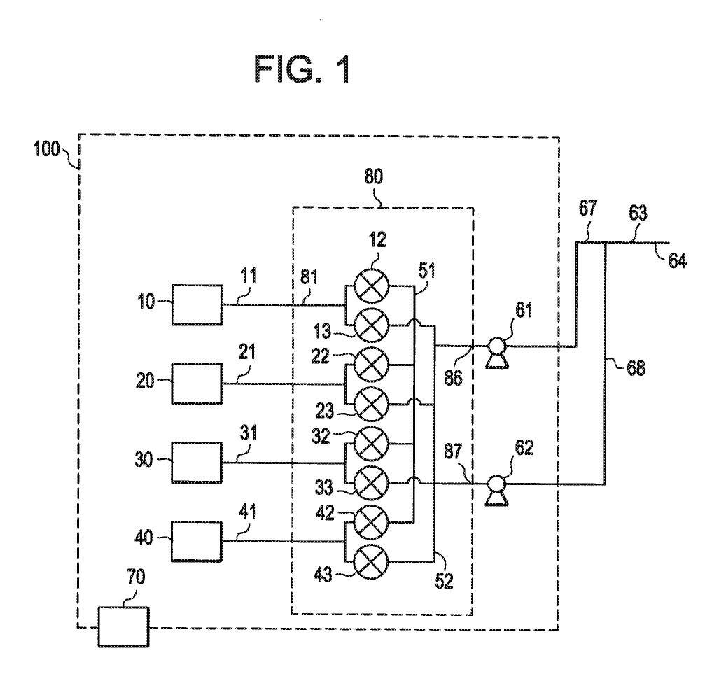

An exemplary solvent feed system of the present invention is shown in FIG. 1. As shown in FIG. 1, exemplary solvent feed system 100 comprises solvent containers 10, 20, 30 and 40; solvent line connectors 11, 21, 31 and 41; high precision valve pairs 12 and 13, 22 and 23, 32 and 33 and 42 and 43; and pumps 61 and 62. Each solvent container within exemplary solvent feed system 100 is in fluid communication with both pumps via a pair of high precision valves for each solvent container. As shown in FIG. 1, fluid streams independently flowing through valves 12, 22, 32 and 42 merge with one another within line 51 prior to entering pump 61, while fluid streams independently flowing through valves 13, 23, 33 and 43 merge with one another within line 52 prior to entering pump 62. Fluid streams exiting pumps 61 and 62 merge with one another at junction 63 to form a single fluid stream along line 64.

A portion of each of solvent line connectors 11, 21, 31 and 41; high precision valve pairs 12 and 13, 22 and 23, 32 and 33 and 42 and 43; and a portion of lines 51 and 52 may form a manifold 80 as shown in FIG. 1. In this exemplary embodiment, manifold 80 comprises four fluid inlets 81, 82, 83 and 84, and two fluid outlets 86 and 87 feeding into lines 51 and 52 respectively.

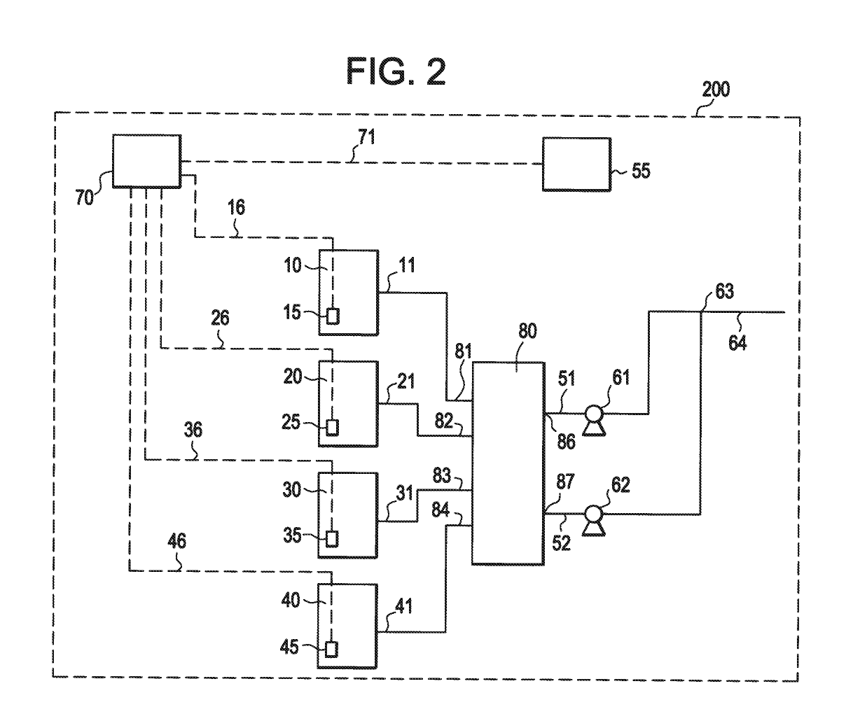

Another exemplary solvent feed system of the present invention is shown in FIG. 2. As shown in FIG. 2, exemplary solvent feed system 200 comprises solvent containers 10, 20, 30 and 40; solvent line connectors 11, 21, 31 and 41 extending into manifold 80; fluid outlet lines 51 and 52; and pumps 61 and 62. Again, in exemplary solvent feed system 200, each solvent container within exemplary solvent feed system 200 is in fluid communication with both pumps via a pair of high precision valves for each solvent container.

Exemplary solvent feed system 200 comprises solvent level sensors 15, 25, 35 and 45 each independently positioned within solvent containers 10, 20, 30 and 40 respectively. Exemplary solvent feed system 200 also comprises room pressure sensor 55. As discussed in detail below, each of solvent level sensors 15, 25, 35 and 45 is operatively adapted to determine a solvent level within a given solvent container based on a room pressure reading from room pressure sensor 55.

Microprocessor 70 is operatively adapted to process signals 16, 26, 36 and 46 from each of solvent level sensors 15, 25, 35 and 45, as well as a signal 71 from room pressure sensor 55 so as to monitor a solvent level within a given solvent container.

As shown in FIGS. 1 and 2, solvent feed systems of the present invention may comprise a number of components. A description of the various components used to form solvent feed systems of the present invention and various component configurations is provided below.

### I. Solvent Feed System Components

The present invention is directed to the following solvent feed system components, which may be used alone or in combination with one another in a variety of fluid flow systems such as chromatography systems.

A. Assembly of Solvent Connections, Valves and Pumps

The present invention is directed to an assembly of solvent connections, high precision valves and pumps as shown in FIG. 1. As shown in FIG. 1, exemplary solvent feed system 100 comprises two or more solvent line connections (e.g., solvent line connectors 11, 21, 31 and 41); at least two pumps (e.g., pumps 61 and 62), wherein each pump of the at least two pumps (i) is in fluid communication with each solvent line connection (e.g., solvent line connectors 11, 21, 31 and 41), and (ii) is in a parallel configuration relative to any other pump of the at least two pumps; and multiple valves (e.g., high precision valve pairs 12 and 13, 22 and 23, 32 and 33 and 42 and 43) comprising a valve positioned between each solvent line connection and each of said at least two pumps.

Although exemplary solvent feed system 100 is shown as comprising four solvent line connections (e.g., solvent line connectors 11, 21, 31 and 41), eight valves (e.g., high precision valve pairs 12 and 13, 22 and 23, 32 and 33 and 42 and 43) and two pumps (e.g., pumps 61 and 62), it should be understood that solvent feed systems of the present invention may comprise as few as two solvent line connections (e.g., solvent line connectors 11 and 21), four valves (e.g., high precision valve pairs 12 and 13, and 22 and 23) and two pumps (e.g., pumps 61 and 62). It should be further noted that solvent feed systems of the present invention may comprise any number of solvent line connections, valves and two pumps as long as the following criteria (also referred to herein as “assembly criteria”) for the resulting assembly are met: x solvent line connections, where x is an integer greater than or equal to 2; y pumps, where y is an integer greater than or equal to 2; and z valves, where z is equal to (x)*(y); each pump is in fluid communication with each solvent line connection; each pump is in a parallel configuration relative to any other pump of the y pumps; and a valve is positioned between each of the x solvent line connection and each of the y pumps.

In one desired embodiment, the solvent feed system of the present invention is similar to exemplary solvent feed system 100 shown in FIG. 1 and comprises four solvent line connections (e.g., solvent line connectors 11, 21, 31 and 41), two pumps (e.g., pumps 61 and 62), and eight valves (e.g., high precision valve pairs 12 and 13, 22 and 23, 32 and 33 and 42 and 43). In other desired embodiments, the solvent feed system of the present invention comprises five or more solvent line connections, two pumps, and ten or more valves, wherein the resulting assembly meets the assembly criteria described above.

As shown in FIG. 1, two or more solvent line connections 11, 21, 31 and 41 and multiple high precision valve pairs 12 and 13, 22 and 23, 32 and 33 and 42 and 43 may comprise a multi-port manifold (e.g., manifold 80) positioned between two or more solvent sources (e.g., solvent containers 10, 20, 30 and 40) and the at least two pumps 61 and 62. The resulting manifold may comprise x fluid inlets, and y fluid outlets, where x and y are integers as described above. It should be noted that although FIG. 1 shows each of solvent line connections 11, 21, 31 and 41 as being adjacent to solvent containers 10, 20, 30 and 40, solvent line connections 11, 21, 31 and 41 may each independently be positioned at any location between a given solvent containers (e.g., solvent container 10) and a fluid inlet of manifold 80 (e.g., fluid inlet 81).

Solvent feed systems of the present invention, such as exemplary solvent feed systems 100 and 200, enable low pressure mixing of one or more solvents between the two or more solvent line connections (e.g., solvent line connections 11, 21, 31 and 41) and any one of the at least two pumps (e.g., pumps 61 and 62). As used herein, the term “low pressure mixing” is used to describe mixing of solvent(s) from two or more solvent line connections (e.g., solvent line connections 11, 21, 31 and 41) prior to entering a pump (e.g., pump 61 or 62). As shown in FIG. 1, exemplary solvent feed system 100 enables (1) low pressure mixing of one or more solvents within line 51 prior to entering pump 61, (2) low pressure mixing of one or more solvents within line 52 prior to entering pump 62, and (3) simultaneous, independent low pressure mixing (i) within line 51 prior to entering pump 61 and (ii) within line 52 prior to entering pump 62.

Solvent feed systems of the present invention, such as exemplary solvent feed systems 100 and 200, also enable high pressure mixing of one or more solvents within the at least two pumps (e.g., pumps 61 and 62) and after exiting the at least two pumps (e.g., pumps 61 and 62). As used herein, the term “high pressure mixing” is used to describe mixing of solvent(s) from two or more solvent line connections (e.g., solvent line connections 11, 21, 31 and 41) upon entering and exiting a pump (e.g., pump 61 or 62). As shown in FIG. 1, exemplary solvent feed system 100 enables (1) high pressure mixing of one or more solvents within pump 61 and line 67 exiting pump 61, (2) high pressure mixing of one or more solvents within pump 62 and line 68 exiting pump 62, (3) high pressure mixing of one or more solvents within line 64 downstream from junction 63, and (4) simultaneous high pressure mixing (i) within pump 61 and line 67 exiting pump 61, (ii) within pump 62 and line 68 exiting pump 62, and (iii) within line 64 downstream from junction 63.

As shown in FIGS. 1 and 2, solvent feed systems of the present invention, such as exemplary solvent feed systems 100 and 200, typically comprise individual fluid streams 67 and 68 exiting the at least two pumps (e.g., pump 61 or 62) that merge into a single fluid stream 64. Further, as shown in FIGS. 1 and 2, solvent feed systems of the present invention, such as exemplary solvent feed systems 100 and 200, may further comprise at least one solvent container (e.g., solvent containers 10, 20, 30 and 40) for each solvent line connection (e.g., solvent line connections 11, 21, 31 and 41).

Solvent feed system of the present invention, such as exemplary solvent feed systems 100 and 200, may typically further comprise at least two different solvents in separate solvent containers, wherein each solvent container (e.g., solvent containers 10, 20, 30 and 40) is independently connected to one solvent line connection (e.g., solvent line connections 11, 21, 31 and 41) of the two or more solvent line connections. It should be understood that solvent feed system of the present invention may utilize one or more solvents, and up to x different solvents, where x is an integer as described above. In some desired embodiments, solvent feed systems of the present invention comprise four different solvents in separate solvent containers (e.g., solvent containers 10, 20, 30 and 40), wherein each solvent container is independently connected to four solvent line connections (e.g., solvent line connections 11, 21, 31 and 41).

As shown in FIGS. 1 and 2, solvent feed systems of the present invention, such as exemplary solvent feed systems 100 and 200, may further comprise microprocessor 70 operatively adapted to send one or more signals (not shown) to each of multiple values 12, 13, 22, 23, 32, 33, 42 and 43 to independently control opening and closing of each of the multiple values. Microprocessor 70 may utilize a software control package comprising software code that is operatively adapted to instruct microprocessor 70 to open and close one or more of multiple values 12, 13, 22, 23, 32, 33, 42 and 43 simultaneously and/or sequentially in order to obtain a gradient solvent composition within lines 51, 52, 67, 68 and 64.

In desired embodiments of the present invention, each high precision valve (e.g., values 12, 13, 22, 23, 32, 33, 42 and 43) is capable of opening or closing at a high rate of speed in response to a signal from microprocessor 70. Desirably, in response to a signal from microprocessor 70, each high precision valve (e.g., values 12, 13, 22, 23, 32, 33, 42 and 43) is capable of opening or closing within 3 seconds, more desirably, less than 3.0 seconds (or less than 3.0 seconds, less than 2.0 seconds, less than 1.5 seconds, less than 1.0 second, less than 0.5 seconds).

B. Combination of Solvent Level Sensors and Room Pressure Sensor

Solvent feed systems of the present invention may comprise at least one solvent level sensor (e.g., solvent level sensors 15, 25, 35 and 45) positioned within each solvent container (e.g., solvent containers 10, 20, 30 and 40). In some embodiments of the present invention, the solvent feed system further comprises at least one room pressure sensor (e.g., room pressure sensor 55), wherein at least one solvent level sensor (e.g., at least one of solvent level sensors 15, 25, 35 and 45) is operatively adapted to determine a solvent level within a solvent container based on a room pressure reading from the at least one room pressure sensor (e.g., room pressure sensor 55). For example, a given solvent level sensor may determine a pressure within a given solvent container and subtract the room pressure obtained from the at least one room pressure sensor (e.g., room pressure sensor 55) from the pressure within the given solvent container to accurately determine a solvent level within the given solvent container.

In one exemplary embodiment of the present invention, the solvent feed system comprises at least one solvent container (e.g., any one or all of solvent containers 10, 20, 30 and 40); at least one solvent level sensor positioned within each solvent container (e.g., at least one of solvent level sensors 15, 25, 35 and 45); and at least one room pressure sensor (e.g., at least one room pressure sensor 55), wherein the at least one solvent level sensor is operatively adapted to determine a solvent level within a solvent container based on a room pressure reading from the at least one room pressure sensor as discussed above. In exemplary embodiments comprising the above-mentioned combination of (i) at least one room pressure sensor (e.g., room pressure sensor 55), and (ii) at least one solvent level sensor (e.g., at least one of solvent level sensors 15, 25, 35 and 45), as described above, the solvent feed system does not comprise an air pump for bubbling air through a given solvent within the at least one solvent container. Such a configuration eliminates the high cost associated with the use of one or more air pumps to determine solvent level within a given solvent container.

In another exemplary embodiment, the solvent feed system of the present invention comprises four solvent line connections (e.g., solvent line connections 11, 21, 31 and 41); four separate solvent containers (e.g., solvent containers 10, 20, 30 and 40), wherein each solvent container is independently connected to a given solvent line connection; two pumps, wherein each pump of the two pumps (i) is in fluid communication with each solvent line connection, and (ii) is in a parallel configuration relative to the other pump of the two pumps (e.g., pump 61 or 62); and multiple valves (e.g., values 12, 13, 22, 23, 32, 33, 42 and 43) comprising a valve positioned between each solvent line connection and each of the two pumps (e.g., pump 61 or 62).

As noted above, even though exemplary solvent feed system 200 depicts an exemplary solvent feed system of the present invention comprising each of the displayed components in combination with one another, any of the displayed components may be used separately in other exemplary solvent feed systems of the present invention. For example, as discussed above, exemplary solvent feed systems of the present invention may comprise the combination of (i) at least one room pressure sensor (e.g., room pressure sensor 55), and (ii) at least one solvent level sensor (e.g., at least one of solvent level sensors 15, 25, 35 and 45), as described above, without manifold 80 shown in FIG. 2 (i.e., without an assembly of solvent connections, high precision valves and pumps meeting the above-mentioned assembly criteria). However, in most embodiments of the present invention, solvent feed systems of the present invention comprise each of the components displayed in exemplary solvent feed system 200 shown in FIG. 2.

As shown in FIG. 2, exemplary solvent feed system 200 also comprises a microprocessor shown as microprocessor 70. Microprocessor 70 is operatively adapted to (1) receive one or more signals (e.g., signals 16, 26, 36 and 46) from (i) the at least one solvent level sensor (e.g., at least one of solvent level sensors 15, 25, 35 and 45, desirably, each of solvent level sensors 15, 25, 35 and 45) and (ii) the at least one room pressure sensor (e.g., at least one room pressure sensor 55, desirably, each of room pressure sensor(s) 55) (e.g., signal 71), and (2) send one or more signals (not shown) to one or more solvent container selectors (not shown), wherein each solvent container selector is operatively adapted to substitute a second solvent container for a first solvent container in response to a signal received from microprocessor 70 that a solvent level within the first solvent container is below a threshold amount. This exemplary embodiment minimizes the amount of user interaction needed to exchange a given solvent container with another solvent container.

It should be noted that although exemplary solvent feed systems 100 and 200 comprise a single microprocessor, namely, microprocessor 70, each solvent feed system may comprise one or more microprocessors to control the above-mentioned components of a given solvent feed system (e.g., valves, pumps, sensors, and/or solvent selectors).

Each microprocessor 70 may be remotely located relative to the other components of exemplary solvent feed systems 100 and 200 or may be directly connected to one or more components within exemplary solvent feed systems 100 and 200. As discussed above, each microprocessor 70 is programmed to (i) recognize signals from various components within exemplary solvent feed systems 100 and 200 (e.g., signals from solvent level sensors and room pressure sensors), and (ii) initiate one or more automated steps in response to receiving one or more signals (e.g., sending instructions to a solvent container selector) or receiving instruction from software code (e.g., opening or closing a valve). As long as microprocessor(s) 70 is capable of (i) recognizing signals from various components within exemplary solvent feed systems 100 and 200, and (ii) initiate one or more automated steps in response to receiving one or more signals or instruction from software code, microprocessor(s) 70 may be in any location relative to exemplary solvent feed systems 100 and 200.

Although not shown in exemplary solvent feed systems 100 and 200, it should be understood that exemplary solvent feed systems 100 and 200 may further comprise one or more user interface stations (e.g., a personal computer, laptop, touch screen, keyboard, etc.), as needed, to enable a user to safely operate exemplary solvent feed systems 100 and 200.

### II. Methods of Making Components

The present invention is also directed to methods of making solvent feed systems, as well as chromatography systems comprising one or more of the herein disclosed solvent feed systems. In one exemplary embodiment, the method of making a solvent feed system comprises providing two or more solvent line connections (e.g., solvent line connections 11, 21, 31 and 41); connecting at least two pumps (e.g., pump 61 or 62) (desirably, high pressure pumps) to the two or more solvent line connections (e.g., solvent line connections 11, 21, 31 and 41), wherein each pump of the at least two pumps (i) is in fluid communication with each solvent line connection, and (ii) is in a parallel configuration relative to any other pump of the at least two pumps; and positioning a valve between each solvent line connection and each pump of the at least two pumps (e.g., values 12, 13, 22, 23, 32, 33, 42 and 43).

In another exemplary embodiment, the method of making a solvent feed system comprises positioning at least one solvent level sensor (e.g., at least one of solvent level sensors 15, 25, 35 and 45) within each solvent container of the system (e.g., solvent containers 10, 20, 30 and 40); and providing at least one room pressure sensor (e.g., at least one room pressure sensor 55) in a room containing each solvent container of the system; wherein the at least one solvent level sensor is operatively adapted to determine a solvent level within a solvent container based on a room pressure reading from the at least one room pressure sensor.

In yet another exemplary embodiment, the method of making a solvent feed system comprises providing at least two solvent container (e.g., solvent containers 10, 20, 30 and 40); connecting each solvent container to a single solvent line connector within a set of two or more solvent line connections (e.g., solvent line connections 11, 21, 31 and 41); connecting at least two pumps (e.g., pump 61 or 62) (desirably, high pressure pumps) to the two or more solvent line connections (e.g., solvent line connections 11, 21, 31 and 41), wherein each pump of the at least two pumps (i) is in fluid communication with each solvent line connection, and (ii) is in a parallel configuration relative to any other pump of the at least two pumps; positioning a valve between each solvent line connection and each pump of the at least two pumps (e.g., values 12, 13, 22, 23, 32, 33, 42 and 43); positioning at least one solvent level sensor (e.g., at least one of solvent level sensors 15, 25, 35 and 45) within each solvent container of the system (e.g., solvent containers 10, 20, 30 and 40); and providing at least one room pressure sensor (e.g., at least one room pressure sensor 55) in a room containing each solvent container of the system; wherein the at least one solvent level sensor is operatively adapted to determine a solvent level within a solvent container based on a room pressure reading from the at least one room pressure sensor.

Any of the above-mentioned exemplary methods of making a solvent feed system may further comprise one or more of the following steps: incorporating at least one microprocessor (e.g., microprocessor 70) into the solvent feed system, wherein the microprocessor(s) is programmed to (i) recognize signals from various components within a given solvent feed system (e.g., exemplary solvent feed systems 100 and 200) (e.g., signals from solvent level sensors and room pressure sensors), and (ii) initiate one or more automated steps in response to receiving one or more signals (e.g., sending instructions to a solvent container selector) or receiving instruction from software code (e.g., opening or closing a valve); loading a software code package into a given solvent feed system (e.g., onto microprocessor 70 of exemplary solvent feed system 100 or 200), wherein the software code package provides instructions to microprocessor(s) 70 for recognizing and sending signals from various components within the solvent feed system; incorporating one or more user interface stations within a given solvent feed system; connecting each solvent container within a set of two or more solvent containers (e.g., solvent containers 10, 20, 30 and 40) to a single solvent line connector within a set of two or more solvent line connections (e.g., solvent line connections 11, 21, 31 and 41); providing one or more solvents into a given solvent feed system; and connecting a given solvent feed system to a fluid flow system such as a chromatography system (e.g., a chromatography column of a flash chromatography system).

### III. Methods of Using Solvent Feed Systems

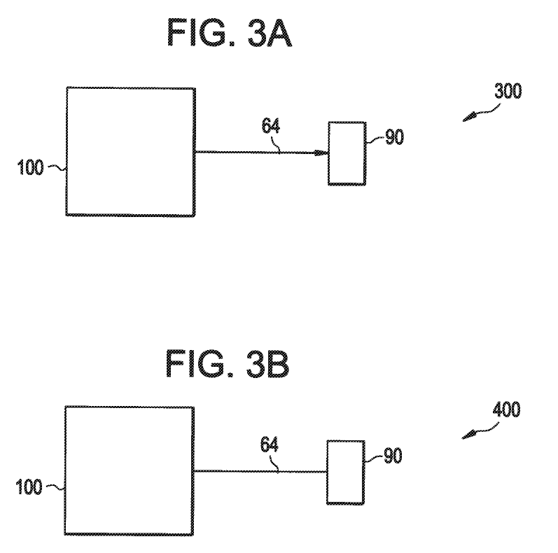

The present invention is further directed to methods of using one or more of the above-described solvent feed systems of the present invention. Methods of using one or more of the above-described solvent feed systems of the present invention may comprise using one or more of the above-described solvent feed systems to introduce a solvent stream (e.g., from line 64 shown in exemplary solvent feed systems 100 and 200) into a chromatography column. FIGS. 3A-3B depict exemplary chromatography systems containing exemplary solvent feed systems 100 and 200 respectively.

As shown in FIG. 3A, exemplary chromatography system 300 comprises exemplary solvent feed system 100 (shown in FIG. 1) in combination with a chromatography column 90, wherein a solvent feed stream from line 64 of exemplary solvent feed system 100 enters into chromatography column 90. In FIG. 3B, exemplary chromatography system 400 comprises exemplary solvent feed system 200 (shown in FIG. 2) in combination with chromatography column 90, wherein a solvent feed stream from line 64 of exemplary solvent feed system 200 enters into chromatography column 90.

Although not shown in FIGS. 3A-3B, it should be understood that exemplary chromatography systems 300 and 400 may comprise any additional components typically found in a given chromatography system (e.g., a fraction collection system, a detector, one or more additional valves, an air source, one or more additional pumps, a waste collector, etc.).

Methods of using one or more of the above-described solvent feed systems of the present invention may comprise using one or more of the above. described solvent feed systems to analyze a test sample in a chromatography system, such as a flash chromatography system. In one exemplary embodiment, the method of analyzing a test sample in a chromatography system comprises the step of introducing a test sample into a solvent stream exiting any one of the above-described solvent feed systems; and routing the solvent stream (with test sample) through a chromatography column.

The present invention is further illustrated by the following examples, which are not to be construed in any way as imposing limitations upon the scope thereof. On the contrary, it is to be clearly understood that resort may be had to various other embodiments, modifications, and equivalents thereof which, after reading the description herein, may suggest themselves to those skilled in the art without departing from the spirit of the present invention and/or the scope of the appended claims.

### EXAMPLES

### Example 1

A Reveleris™ Flash Chromatography System is configured as follows:

(a) Solvent containers 1 and 2 are filled with hexane

(b) Solvent containers 2 and 3 are filled with ethyl acetate

(c) A solvent level sensor is placed in each reservoir

(d) All four solvent containers are connected to a manifold with valves that will connect any of the four solvent bottles to any of pumps 1 and 2 operating in parallel to each other.

A microprocessor controlling the pumping system is set to deliver a 80/20 hexane ethyl acetate mixture at 25 mL/min to a Reveleris™ 12 g silica cartridge using high pressure mixing by combining the outputs from pumps 1 and 2, connected to solvent containers 1 and 3, respectively. A 2 mL sample of 100 mg/ml butyl paraben was injected and separated in a 10 minute run repeatedly on the Reveleris™ cartridge. After 16 runs, the hexane in solvent container 1 was empty. The level sensor in solvent container 1 signaled the microprocessor that the reservoir was empty and instructed the valves to automatically close off solvent reservoir 1 and activate solvent reservoir 2. This action allowed the system to process another 16 separations without operator intervention.

While the invention has been described with a limited number of embodiments, these specific embodiments are not intended to limit the scope of the invention as otherwise described and claimed herein. It may be evident to those of ordinary skill in the art upon review of the exemplary embodiments herein that further modifications, equivalents, and variations are possible. All parts and percentages in the examples, as well as in the remainder of the specification, are by weight unless otherwise specified. Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, R_{L}, and an upper limit R_{U}, is disclosed, any number R falling within the range is specifically disclosed. In particular, the following numbers R within the range are specifically disclosed: R=R_{L}+k(R_{U}−R_{L}), where k is a variable ranging from 1% to 100% with a 1% increment, e.g., k is 1%, 2%, 3%, 4%, 5%. . . . 50%, 51%, 52%. . . . 95%, 96%, 97%, 98%, 99%, or 100%. Moreover, any numerical range represented by any two values of R, as calculated above is also specifically disclosed. Any modifications of the invention, in addition to those shown and described herein, will become apparent to those skilled in the art from the foregoing description and accompanying drawings. Such modifications are intended to fall within the scope of the appended claims. All publications cited herein are incorporated by reference in their entirety.

What is claimed is:

1. A solvent feed system comprising:
(a) two or more solvent line connections;
(b) at least two pumps, wherein each pump of said at least two pumps (i) is in fluid communication with each solvent line connection, and (ii) is in a parallel configuration relative to any other pump of said at least two pumps; and
(c) multiple valves comprising a valve positioned between each solvent line connection and each of said at least two pumps.

2. The solvent feed system of claim 1, wherein said two or more solvent line connections and said multiple valves comprise a multi-port manifold positioned between said two or more solvent sources and said at least two pumps.

3. The solvent feed system of claim 1, wherein said system enables low pressure mixing of one or more solvents between said two or more solvent line connections and any one of said at least two pumps.

4. The solvent feed system of claim 1, wherein individual fluid streams exiting said at least two pumps merge into a single fluid stream.

5. The solvent feed system of claim 1, said system comprising four solvent line connections, two pumps, and eight valves.

6. The solvent feed system of claim 1, further comprising:
(a) at least one solvent container for each solvent line connection.

7. The solvent feed system of claim 6, further comprising:
(a) at least one solvent level sensor positioned within each solvent container.

8. The solvent feed system of claim 7, further comprising:
(a) at least one room pressure sensor,
(b) wherein said at least one solvent level sensor is operatively adapted to determine a solvent level within a solvent container based on a room pressure reading from said at least one room pressure sensor.

9. The solvent feed system of claim 1, further comprising:
(a) at least two different solvents in separate solvent containers, wherein each solvent container is independently connected to one solvent line connection of said two or more solvent line connections.

10. The solvent feed system of claim 1, further comprising:
(a) four different solvents in separate solvent containers, wherein each solvent container is independently connected to four solvent line connections.

11. The solvent feed system of claim 1, further comprising:
(a) a software control package, said software control package comprising software code operatively adapted to control opening and closing of each valve.

12. The solvent feed system of claim 11, wherein each valve is capable of opening or closing within 3.0 seconds.

13. The solvent feed system of claim 11, further comprising:
(a) a microprocessor operatively adapted to send one or more signals to each of said multiple values to independently control opening and closing of each of said multiple values.

14. The solvent feed system of claim 1, in combination with a chromatography column, wherein said chromatography column is in fluid communication with a fluid stream exiting said at least two pumps.

15. A flash chromatography system comprising the combination of claim 14.

16. A solvent feed system comprising:
(a) at least one solvent container;
(b) at least one solvent level sensor positioned within each solvent container; and
(c) at least one room pressure sensor,
(d) wherein said at least one solvent level sensor is operatively adapted to determine a solvent level within a solvent container based on a room pressure reading from said at least one room pressure sensor.

17. The solvent feed system of claim 16, wherein said solvent feed system does not comprise an air pump for bubbling air through a given solvent within said at least one solvent container.

18. The solvent feed system of claim 16, further comprising:
(a) four solvent line connections;
(b) four separate solvent containers, wherein each solvent container is independently connected to a given solvent line connection;
(c) two pumps, wherein each pump of said two pumps (i) is in fluid communication with each solvent line connection, and (ii) is in a parallel configuration relative to the other pump of said two pumps; and
(d) multiple valves comprising a valve positioned between each solvent line connection and each of said two pumps.

19. The solvent feed system of claim 15, further comprising:
(a) a microprocessor operatively adapted to (1) receive one or more signals from (i) said at least one solvent level sensor and (ii) said at least one room pressure sensor, and (2) send one or more signals to one or more solvent container selectors, wherein each solvent container selector is operatively adapted to substitute a second solvent container for a first solvent container in response to a signal received from said microprocessor that a solvent level within the first solvent container is below a threshold amount.

20. A flash chromatography system comprising the solvent feed system of claim 15.

21. A method of introducing a solvent stream into a chromatography column, said method comprising the step of:
(a) supplying a solvent stream from the solvent feed system of claim 1.

22. A method of analyzing a test sample in a chromatography system, said method comprising the step of:
(a) introducing a test sample into a solvent stream from the solvent feed system of claim 1; and
(b) routing the solvent stream through a chromatography column.

23. A method of making a solvent feed system, said method comprising:
(a) providing two or more solvent line connections;
(b) connecting at least two pumps to the two or more solvent line connections, wherein each pump of said at least two pumps (i) is in fluid communication with each solvent line connection, and (ii) is in a parallel configuration relative to other pumps of said at least two pumps; and
(c) positioning a valve between each solvent line connection and each pump of said at least two pumps.

24. A solvent feed system comprising:
(a) a manifold having at least two valves;
(b) at least two first solvent lines in fluid communication with the valves;
(c) at least one pump in fluid communication with the valves through the solvent lines; and
(d) at least one second solvent line;
(e) wherein the first solvent lines are in fluid communication with each other before or at an inlet of the pump and in fluid communication with the second solvent line after an outlet of the pump.

25. A method of making a solvent feed system, said method comprising:
(a) providing a manifold having at least two valves;
(b) connecting at least two first solvent lines to the valves;
(c) connecting at least one pump to the two or more solvent lines such that the pump is in fluid communication with the valves;
(d) providing at least one second solvent line;
(e) wherein the first solvent lines are in fluid communication with each other before or at an inlet of the pump and in fluid communication with the second solvent line after an outlet of the pump.
